(19) United States
(12) Patent Application Publication
(10) Pub. No.: US 2022/0384863 A1
(43) Pub. Date: Dec. 1, 2022

(54) METHOD FOR CHARGING AND/OR DISCHARGING A RECHARGEABLE ENERGY STORE

(71) Applicant: Benning CMS Technology GmbH, March (DE)

(72) Inventor: Wolfram WALTER, Eschbach (DE)

(73) Assignee: Benning CMS Technology GmbH, March (DE)

(21) Appl. No.: 17/770,104

(22) PCT Filed: Oct. 28, 2020
(86) PCT No.: PCT/DE2020/100922

§ 371 Date: Apr. 19, 2022

(30) Foreign Application Priority Data
Oct. 31, 2019 (DE) 10 2019 129 415.0

(51) Int. Cl. H01M 10/44; H01M 10/48; H02J 7/00

(52) U.S. Cl. CPC H01M 10/441; H01M 10/482; H02J 7/0016; H02J 7/007182; H02J 7/005; H02J 2207/20

(57) ABSTRACT

A method for charging and/or discharging an energy store with a current I₀, wherein the energy store has at least one cell block having a number J of series-connected battery cells, at least some of the battery cells of which may have different efficiencies η_{N}, where 1≤N≤J, has the following method steps: determining the battery cell having the lowest efficiency ηₘᵢₙ, and adjusting the efficiency η_{N} of all the other battery cells to this lowest efficiency ηₘᵢₙ such that the adjusted efficiency η_{N′} of the battery cells is n_{N′}=ηₘᵢₙ.

The invention relates to a method for charging and discharging a rechargeable energy store, wherein the energy store has at least one cell block having a number J of series-connected battery cells.

An energy store comprises multiple galvanic cells connected in series or in parallel and referred to as battery cells. When the battery cells are being discharged, stored chemical energy is converted into electrical energy. This electrical energy can be used by a consumer that is independent of the electricity grid, such as an electric vehicle. Furthermore, the electrical energy of the energy store can be used by a consumer that is integrated into the electricity grid in order to bridge an interruption in the power supplied through the electricity grid. The energy store comprising rechargeable battery cells is recharged after a discharge in order to be available for the next use.

In the case of energy stores (accumulators) consisting of multiple series-connected, rechargeable battery cells, it is important, among other things, for the service life of the energy store that each individual cell is neither overcharged when the energy store is charged nor too deeply discharged when the energy store is discharged and that all cells have the same state of charge where possible. This applies in particular to energy stores consisting of multiple series-connected lithium-ion batteries, lithium-polymer batteries and/or lithium-iron-phosphate batteries.

In general, such energy stores are therefore connected to a device, often also referred to as a battery management system, which on the one hand constantly monitors the state of charge of the individual battery cells by means of a charge control device and on the other hand attempts to equalise the individual battery cells should they have different states of charge. The states of charge of the battery cells can be equalised by passive or active balancing. In addition, in known battery management systems charge equalisation only begins when at least one of the battery cells is fully charged, so the entire charging process of a cell block is relatively time-consuming.

In the case of passive balancing, the battery cell that reaches its end-of-charge voltage first converts the surplus energy into heat via a resistor, thus rendering it lost for the charging process.

In the case of active balancing, on the other hand, the energy removed from a battery cell with too high a cell voltage is not converted into thermal energy, but is used to charge the other cells of the energy store. However, even in the case of active balancing, charge equalisation only begins when at least one of the battery cells of the cell block has reached its end-of-charge voltage.

A method for charging and discharging an energy store having at least one cell block consisting of multiple series-connected battery cells without active or passive balancing is known from DE 10 2017 009 850 A1. In this known method all battery cells reach their end-of-charge or end-of-discharge voltage simultaneously. To that end, and having due regard fora specified C factor which corresponds to the quotient of the maximum charging current I_{N;max} to the capacitance C_{N} of each of the battery cells, the characteristic maximum charging current I_{N;max} of each battery cell is determined from its capacitance C_{N}. During a specified time t which is less than or equal to the reciprocal of the C factor, all battery cells are charged simultaneously at their respectively determined maximum charging currents I_{N;max}. The difference between the available charging current I₀ and the maximum charging current I_{N;max} of a battery cell is taken from or added to the cell block as an auxiliary charging current by means of auxiliary charging/discharging devices. Discharging is performed analogously.

The object of the invention is to provide a method for charging and discharging an energy store having series-connected battery cells wherein all battery cells are charged simultaneously and reach their end-of-charge voltage simultaneously and wherein there is no need for auxiliary charging currents or auxiliary discharging currents.

This object is achieved by a method for charging and/or discharging according to claim 1. The method is characterised in that where an energy store has at least one cell block having a number J of series-connected battery cells which may have different efficiencies η_{N}, where 1≤N≤J, the battery cell with the lowest efficiency ηₘᵢₙ of the cell block is determined. The efficiency of all other battery cells is subsequently adjusted to this lowest efficiency ηₘᵢₙ.

The efficiency η_{N} describes the efficiency of the Nth battery cell of the cell block of the energy store as a quotient of the usable energy E_{N} and the added energy E₀. The following applies:

η_{N}=E_{N}/E₀

η_{N} can be a value between 0 and 1.

The efficiency of a battery cell is affected by all resistances of the battery cell and the age condition of the battery cell, also known as the state of health (SoH).

The battery cell with the lowest efficiency ηₘᵢₙ is the battery cell for which, with supplied energy E₀ that is the same for all battery cells of the cell block of the energy store, the usable energy E_{N} is less than that of all other battery cells. It is assumed that this is caused by losses which are greater for the battery cell concerned than for the other battery cells. Since the losses of the battery cells differ, with an added energy E₀ for all battery cells and a charging current I₀, not all battery cells are charged at the same capacitance.

To ensure that all battery cells reach their end-of-charge voltage simultaneously, the efficiency of all battery cells is adjusted to the efficiency ηₘᵢₙ, so that all battery cells are subject to the same losses as the battery cell that has the lowest efficiency from the beginning. In this context the end-of-charge voltage can be the maximum permitted charge voltage indicated by the manufacturer on the data sheet or a voltage defined by the operator of the energy store which may be below the voltage specified by the manufacturer. This applies analogously for the end-of-discharge voltage.

Before the efficiencies η_{N} of the battery cells are adjusted to ηₘᵢₙ, the battery cell with the best efficiency when charging is the first to reach its end-of-charge voltage. This is determined on the basis of the cell voltage. This battery cell has the highest cell voltage in the system. The cell with the lowest efficiency ηₘᵢₙ has the lowest cell voltage in the system.

The aim is for all cells to be fully charged almost simultaneously, i.e. that they reach their maximum end-of-charge voltage simultaneously. Since the cell with the worst efficiency ηₘᵢₙ is the last one to reach this voltage, however, the invention proposes that the other battery cells, which have a better efficiency, be adjusted to the battery cell with the lowest efficiency ηₘᵢₙ so that all battery cells in the series circuit have the identical efficiency η_{N′}=ηₘᵢₙ.

Since the capacitances that make the difference in efficiency are very small, there is no significant deterioration in the efficiency of the battery block as a whole.

The cell voltages of the individual battery cells are preferably measured continuously and transmitted to a monitoring and storage device. In the discharging and subsequent charging process energy is taken from the battery cell that is the first to be fully charged, for example through the time-limited activation of a resistor, controlled by the monitoring and storage device, so that this battery cell appears to be adjusted in efficiency to the battery cell with the lowest efficiency. Energy is taken from all other battery cells in the same manner, such as by means of a resistor. Only from the battery cell with the lowest efficiency ηₘᵢₙ no energy is taken.

The energy or power E_{taken,N} taken from each battery cell is preferably calculated by a monitoring and storage device. The energy or power to be taken is, for example, taken through a time-limited parallel connection of a resistor, wherein the battery cell with the best efficiency η_{N} has the longest resistor switching time and the switching time of the resistor for the battery cell with the lowest efficiency ηₘᵢₙ is equal to zero.

In the next charging process all cells should now reach the end-of-charge voltage simultaneously. If this is not the case, it is calculated again from which cells how much energy must be taken until all cells reach their end-of-charge voltage at the same time. Preferably, the method is self-learning and adapts constantly in each full charging process.

When the condition is reached wherein all cells reach their maximum end-of-charge voltage almost simultaneously, the cell block is preferably discharged once until the first battery cell has reached its end-of-discharge voltage. The capacitance determined thereby is multiplied by the number of cells. The result corresponds to the maximum capacitance that can be taken for this cell block.

The depth of discharge (DoD) relating to this cell, for instance 80%, can now be set for the entire block and the cell block operated in normal mode. It is now no longer possible for a battery cell to be discharged at more than 80%, so that the cell block has a much longer service life than a cell block without this method of adjusting efficiency.

Advantageously, it is checked during each charging process whether all battery cells reach their end-of-charge voltage at the same time. Should a battery cell not reach the specified end-of-charge voltage, this battery cell has deteriorated in efficiency due to age. If the battery cell is the one with the lowest efficiency, all other battery cells will have to be adjusted to this battery cell again. If the battery cell with the deteriorated efficiency is a battery cell which differs from the battery cell with the lowest efficiency, it will be sufficient to adjust the efficiency of this battery cell again. This is done, for instance, by reducing the switching time of a resistor connected in parallel to the battery cell. Should even a reduction in the switching time to zero not be sufficient for the battery cell together with the other battery cells to reach its end-of-charge voltage, this battery cell has replaced the previous battery cell with the lowest efficiency. The efficiency of all other battery cells must consequently also be adjusted.

In this manner an additional parameter for the age condition SoH of the entire cell block is obtained.

In the next step the new value for the maximum capacitance that can be taken from the cell block can be determined through a new capacitance measurement, and the DoD then derived in turn.

The maximum charging or discharging time is the same for all battery cells and much shorter than in known methods with active or passive balancing. If this charging or discharging time is observed, no overcharging or deep discharging of individual battery cells occurs.

Since all battery cells, regardless of their respective capacitance, have the same state of charge after the maximum charging time in relation to their respective usable capacitance, there is no need for additional active or passive balancing.

The energy store is discharged analogously to charging. A discharging current flows instead of a charging current. The current I₀ stands for the charging current in charging and the discharging current in discharging. To differentiate between them, the charging current can be referred to as I₀ and the discharging current as I₀′.

According to an advantageous embodiment of the invention, prior to the adjustment of the efficiencies η_{N} to ηₘᵢₙ the battery cell with the lowest efficiency ηₘᵢₙ is determined in that all cells in the cell block are first charged to their end-of-charge voltage, the cell block is then discharged to a specific proportion of its nominal capacitance and the cell block is subsequently charged until at least one battery cell has reached its end-of-charge voltage. The battery cell with the lowest efficiency ηₘᵢₙ is then defined as the battery cell which has the smallest cell voltage U_{Zmin} of all battery cells.

According to a further advantageous embodiment of the invention, the cell voltage U_{Z0,N} of all battery cells is determined after the cell block has finished being charged. For each of the battery cells, the energy or the power E_{taken,N} which is taken from the respective battery cell during charging or discharging is determined from the difference U_{Z0,N}−U_{Zmin}, so that its adjusted efficiency η_{N′} corresponds to the efficiency ηₘᵢₙ.

According to a further advantageous embodiment of the invention, prior to the adjustment of the efficiencies η_{N} to ηₘᵢₙ the battery cell with the lowest efficiency ηₘᵢₙ is determined in that the cell block is charged and a charging current I₀ is stepped at least once while the cell block is being charged. With all battery cells the cell voltage is recorded over a period of time before, during and after the step change in the charging current I₀. For each battery cell, the difference U_{N,current step} between the highest cell voltage U_{N,max} and the lowest cell voltage U_{N,min} over this period of time is formed: U_{N,current step}=U_{N,max}−U_{N,min}. This is referred to as the voltage response to the stepped change in the charging current. The battery cell with the lowest efficiency ηₘᵢₙ is defined as the battery cell for which the difference U_{N,current step} is the greatest, named U_{current step,max}.

According to a further advantageous embodiment of the invention, prior to the adjustment of the efficiencies η_{N} to ηₘᵢₙ the battery cell with the lowest lowest ηₘᵢₙ is determined in that the cell block is discharged and the discharging current I₀′ is Stepped at least once while the cell block is being discharged. With all battery cells, the cell voltage is recorded over a period of time before, during and after the step change in the discharging current I₀′. For each battery cell, the difference U_{N,current step} between the highest cell voltage U_{N,max} and the lowest cell voltage U_{N,min} over this period of time is formed: U_{N,current step}=U_{N,max}−U_{N,min}. This is referred to as the voltage response to the stepped change in the discharging current. The battery cell with the lowest efficiency ηₘᵢₙ is defined as the battery cell for which the difference U_{N,current step} is the greatest, named U_{current step,max}.

According to a further advantageous embodiment of the invention, for each of the battery cells the energy or power E_{taken,N} that is taken from the respective battery cell during charging or discharging is determined from the difference U_{current step,max} and U_{N,current step}, so that its efficiency corresponds to the efficiency ηₘᵢₙ.

According to a further advantageous embodiment of the invention, for each battery cell the energy or power E_{taken,N}, that is taken from the respective battery cell during charging or discharging so that its efficiency corresponds to the efficiency ηₘᵢₙ is stored.

According to a further advantageous embodiment of the invention, the cell voltages U_{Z0,N} or the efficiencies η_{N} derived from the cell voltages are stored.

According to a further advantageous embodiment of the invention, the capacitance of the battery cell with the lowest efficiency ηₘᵢₙ is determined at specified intervals of time.

According to a further advantageous embodiment of the invention, the cell voltages of all battery cells are measured regularly.

According to a further advantageous embodiment of the invention, at certain intervals immediately after the cell block has been charged the cell voltage U_{Z,N} of all battery cells is determined and compared with the end-of-charge voltage U_{L,N}. In the event that the cell voltage U_{Z,N} of the battery cell with the lowest efficiency η_{N}=ηₘᵢₙ deviates from the end-of-charge voltage U_{L,N} by more than a specified limit value, the energy or the power, that is taken from all other battery cells for the adjustment of its efficiency to the efficiency ηₘᵢₙ, is adjusted. If such a deviation of the cell voltage U_{Z,N} from the end-of-charge voltage U_{L,N} by more than a specified limit value occurs in another battery cell, only in the case of this battery cell the energy or the power, that is taken from this battery cell for the adjustment of its efficiency to the efficiency ηₘᵢₙ, is adjusted. This presupposes that the efficiency η_{N} of the battery cell concerned is still greater than ηₘᵢₙ despite the deterioration. If, for instance, it is necessary to reduce the energy or the power that is taken from this battery cell to zero and this battery cell still shows a deviation between the cell voltage U_{Z,N} and the end-of-charge voltage U_{L,N} that exceeds the specified limit value the next time the cell block is charged, this battery cell becomes the battery cell with the lowest efficiency η_{N}=η_{min′}. The energy or the power that is taken from all other battery cells for the adjustment of its efficiency to the efficiency η_{min′} is consequently adjusted. This procedure serves to compensate for a deterioration in the efficiency of individual battery cells during continuous operation.

According to a further advantageous embodiment of the invention, the charging current I₀ is stepped at least once while the cell block is being charged and the resulting voltage responses of the battery cells are compared with one another. If the efficiencies η_{N} of the battery cells are adjusted such that η_{N′}=ηₘᵢₙ, the voltage responses of all battery cells should be substantially of the same quality and lie within a specified range. If the voltage response of at least one of the battery cells deviates from that of the other battery cells by more than a specified limited value, the efficiency of this battery cell or that of the other battery cells is adjusted again. This can be done as described above, for instance. Alternatively, the discharging current can be stepped at least once while the cell block is being discharged and the resulting voltage responses of the batteries can then be verified.

According to a further advantageous embodiment of the invention, the efficiency is adjusted using switchable resistors R_{N}, whereby each battery cell is equipped with one switchable resistor.

According to a further advantageous embodiment of the invention, the resistor R_{N} of the battery cells is set such that for each combination of battery cell and associated switchable resistor the efficiency is η_{N′}=ηₘᵢₙ.

According to a further advantageous embodiment of the invention, a switchable resistor is only connected in parallel over a period of time of the charging process or discharging process of a battery cell. The resistor concerned is not connected in parallel to the associated battery cell for the entirety of the charging process or discharging process. The parallel connection is interrupted for a portion of the charging process or discharging process. If the efficiencies of the battery cells are adjusted by activating a parallel-connected resistor, the switching time of the resistors can be derived from the ratio of the voltage steps of the battery cells to one another. In particular, the switching time of the resistors can be set equal to the inverse ratio of the voltage steps of the battery cells. No energy is taken by means of a resistor from the battery cell with the lowest efficiency; energy is taken for the longest time from the battery cell with the best efficiency by means of a parallel resistor.

According to a further advantageous embodiment of the invention, the duration of the period of time for each battery cell is set such that for each combination of battery cell and associated switchable resistor the efficiency η_{N′} equals ηₘᵢₙ.

According to a further advantageous embodiment of the invention, the value of the resistance for each battery cell is set such that for each combination of battery cell and associated switchable resistor the efficiency η_{N′} equals ηₘᵢₙ.

According to a further advantageous embodiment of the invention, the efficiency is adjusted using DC-DC converters, wherein each battery cell is equipped with one DC-DC converter and the DC-DC converter is set such that for each combination of battery cell and DC-DC converter the efficiency η_{N′} equals ηₘᵢₙ.

According to a further advantageous embodiment of the invention, while the cell block is being charged the associated voltage of each battery cell is measured when the end-of-charge voltage of the cell block is reached. The measured voltages are compared with one another.

According to a further advantageous embodiment of the invention, the adjustment of the efficiency η_{N} of a battery cell to ηₘᵢₙ is modified if the cell voltage of this battery cell measured when the end-of-charge voltage of the cell block is reached differs from the cell voltage of the other battery cells by more than a specified limit value.

Further advantages and advantageous embodiments of the invention can be obtained from the following description, the drawing and the claims.

### DRAWING

The drawing shows a model embodiment of the subject matter of the invention. Illustration:

FIG. 1 Wiring diagram of an energy store.

### DESCRIPTION OF THE MODEL EMBODIMENT

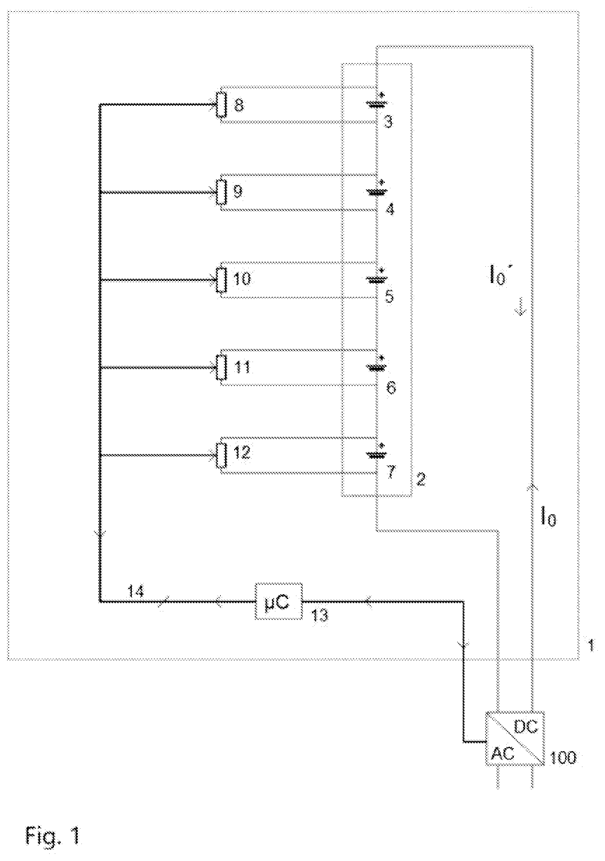

FIG. 1 represents a wiring diagram of an energy store 1 that is used, for example, to supply energy to a supply network of a building and can be charged and discharged by a system for generating renewable energy (photovoltaic installation, wind turbine, biogas plant, etc.), for example via a bidirectional AC/DC converter 100. In the model embodiment represented the energy store 1 comprises a cell block 2 having multiple rechargeable battery cells 3, 4, 5, 6, 7 connected to one another in series. Each of the battery cells 3 to 7 is equipped with a switchable resistor 8, 9, 10, 11, 12, whereby the switchable resistor 8 of the battery cell 3 is connected in parallel. The same applies analogously for the resistors 9, 10, 11, 12 and the battery cells 4, 5, 6, 7. Switchable means that the resistors are connected in parallel to the battery cells for a limited period of time while the cell block is being charged or discharged.

A monitoring and storage device 13 which is connected via corresponding data lines 14 both to the switchable resistors 8 to 12 and to the bidirectional AC/DC converter 100 is provided to check the state of charge or discharge of the individual battery cells 3 to 7.

The determination of the battery cell with the lowest efficiency and the adjustment of the efficiencies of the other battery cells to this lowest efficiency are described below:

All battery cells 3 to 7 in the cell block 2 are first charged until they reach their end-of-charge voltage. The cell block 2 is then discharged until it reaches 50% of its nominal capacitance. The cell block is subsequently charged again until one of the battery cells is the first to reach its end-of-charge voltage. In this model embodiment let it be the battery cell 5. At the moment the battery cell 5 reaches its end-of-charge voltage, the voltage differences between the cell voltage of the battery cell 5 and the cell voltages of the other battery cells 3, 4, 6, 7 are determined. The voltage differences allow conclusions to be drawn about the differences in efficiency. The battery cell 3, 4, 6, 7 which has the greatest voltage difference to the battery cell 5 is defined as the battery cell with the lowest efficiency ηₘᵢₙ. In this model embodiment let it be the battery cell 6.

The efficiencies η_{N} at N ϵ{3, 4, 5, 7} of the battery cells 3, 4, 5, 7 are subsequently adjusted to the efficiency ηₘᵢₙ in that the switching times of the switchable resistors 8 to 12 for the charging process and discharging process are determined. In the case of the battery cell 6, the associated resistor 11 is not connected in parallel during the charging process or the discharging process since the efficiency of this battery cell is already the lowest efficiency: η₆=ηₘᵢₙ. In the case of the battery cell with the best efficiency, in this model embodiment the battery cell 5, the associated switchable resistor 10 is switched on for the longest time.

Switching the switchable resistors 8, 9, 10 and 12 ensures that the losses during the charging and discharging of all battery cells 3 to 7 are the same and therefore the efficiency of all battery cells 3 to 7 corresponds to the efficiency ηₘᵢₙ: η₃=η₄=η₅=η₆=η₇=ηₘᵢₙ

All battery cells 3 to 7 thereby reach their end-of-charge voltage simultaneously when the cell block 2 is being charged.

All features of the invention can be material to the invention both individually and in any combination.

### REFERENCE NUMBERS

1 Energy store
2 Cell block
3 Battery cell
4 Battery cell
5 Battery cell
6 Battery cell
7 Battery cell
8 Switchable resistor
9 Switchable resistor
10 Switchable resistor
11 Switchable resistor
12 Switchable resistor
13 Monitoring and storage device
14 Data line
100 Bidirectional AC/DC converter

1: A method for charging and/or discharging an energy store (1) with a current I₀, wherein the energy store (1) has at least one cell block (2) having a number J of series-connected battery cells (3, 4, 5, 6, 7), at least some of the battery cells (3, 4, 5, 6, 7) of which may have different efficiencies η_{N}, where 1≤N≤J, having the following method steps:
determining the battery cell (3, 4, 5, 6, 7) having the lowest efficiency ηₘᵢₙ,
adjusting the efficiency η_{N} of all the other battery cells (3, 4, 5, 6, 7) to this lowest efficiency ηₘᵢₙ such that for the adjusted efficiency η_{N′} of the battery cells applies: η_{N′}=ηₘᵢₙ.

2: The method according to claim 1, wherein prior to the adjustment of the efficiencies η_{N} to ηₘᵢₙ the battery cell (3, 4, 5, 6, 7) with the lowest efficiency ηₘᵢₙ is determined wherein all battery cells (3, 4, 5, 6, 7) in the cell block (2) are first charged to their end-of-charge voltage, the cell block (2) is then discharged to a specific proportion of its nominal capacitance, the cell block (2) is subsequently charged until at least one battery cell (3, 4, 5, 6, 7) has reached its end-of-charge voltage and the battery cell (3, 4, 5, 6, 7) with the lowest efficiency ηₘᵢₙ is then defined as the battery cell which has the smallest cell voltage U_{Zmin} of all battery cells (3, 4, 5, 6, 7).

3: The method according to claim 2, wherein after the cell block has finished being charged the cell voltage U_{Z0,N} for all battery cells (3, 4, 5, 6, 7) is determined and wherein for each of the battery cells (3, 4, 5, 6, 7) the energy or the power E_{taken,N} that is taken from the respective battery cell (3, 4, 5, 6, 7) during charging or discharging is determined from the difference U_{Z0,N}−U_{Zmin}, so that its thus adjusted efficiency η_{N′} corresponds to the efficiency ηₘᵢₙ.

4: The method according to claim 3, wherein the cell voltages U_{Z0,N} or the efficiencies η_{N} derived from the cell voltages are stored.

5: The method according to claim 1, wherein prior to the adjustment of the efficiencies η_{N} to ηₘᵢₙ the battery cell with the lowest efficiency ηₘᵢₙ is determined wherein the cell block (2) is charged and while the cell block (2) is being charged a charging current I₀ is stepped at least once, wherein the cell voltage of all battery cells (3, 4, 5, 6, 7) is recorded over a period of time before, during and after the step change in the charging current I₀, wherein for every battery cell (3, 4, 5, 6, 7) the difference U_{N,current step} between the highest cell voltage U_{N,max} and the lowest cell voltage U_{N,min} over this period of time is formed at U_{N,current step}=U_{N,max}−U_{N,min}, and wherein the battery cell (3, 4, 5, 6, 7) with the lowest efficiency ηₘᵢₙ is defined as the battery cell (3, 4, 5, 6, 7) for which the difference U_{N,current step} is greatest with U_{current step,max}.

6: The method according to claim 1, wherein prior to the adjustment of the efficiencies η_{N} to ηₘᵢₙ the battery cell with the lowest efficiency ηₘᵢₙ is determined wherein the cell block (2) is discharged and while the cell block is being discharged a discharging current I₀ is stepped at least once, wherein the cell voltage of all battery cells (3, 4, 5, 6, 7) is recorded over a period of time before, during and after the step change in the discharging current I₀, wherein for every battery cell (3, 4, 5, 6, 7) the difference U_{N,current step} between the highest cell voltage U_{N,max} and the lowest cell voltage U_{N,min} over this period of time is formed at U_{N,current step}=U_{N,max}−U_{N,min}, and wherein the battery cell (3, 4, 5, 6, 7) with the lowest efficiency ηₘᵢₙ is defined as the battery cell (3, 4, 5, 6, 7) for which the difference U_{N,current step} is greatest with U_{current step,max}.

7: The method according to claim 5, wherein for each of the battery cells (3, 4, 5, 6, 7) the energy or power E_{taken,N} that is taken from the respective battery cell during charging or discharging is determined from the difference U_{current step,max} and U_{N,current step}, so that its thus adjusted efficiency η_{N′} corresponds to the efficiency ηₘᵢₙ.

8: The method according to claim 3, wherein for each battery cell (3, 4, 5, 6, 7) the energy or the power E_{taken,N}, that is taken from the respective battery cell (3, 4, 5, 6, 7) during charging or discharging, so that its adjusted efficiency η_{N′} corresponds to the efficiency ηₘᵢₙ, is stored.

9: The method according to claim 1, wherein the capacitance of the battery cell (3, 4, 5, 6, 7) with the lowest efficiency ηₘᵢₙ is determined.

10: The method according to claim 1, wherein the cell voltages of the battery cells (3, 4, 5, 6, 7) are measured regularly after the cell block has been charged.

11: The method according to claim 1, wherein at certain intervals immediately after charging the cell block the cell voltage U_{Z,N} of all battery cells (3, 4, 5, 6, 7) is determined and compared with the end-of-charge voltage U_{L,N}, and wherein in the event of a deviation of the cell voltage U_{Z,N} of a battery cell (3, 4, 5, 6, 7) from its end-of-charge voltage U_{L,N} by more than a specified limit value the energy or the power E_{taken,N}, that is taken from the relevant battery cell (3, 4, 5, 6, 7) or all other battery cells for the adjustment of its efficiency to the efficiency ηₘᵢₙ, is adjusted.

12: The method according to claim 11, wherein in the event of a deviation of the cell voltage U_{Z,N} of the battery cell (3, 4, 5, 6, 7) with the lowest efficiency η_{N}=ηₘᵢₙ from the end-of-charge voltage U_{L,N} by more than a specified limit value, the energy or the power E_{taken,N}, that is taken from all other battery cells (3, 4, 5, 6, 7) for the adjustment of its efficiency to the efficiency ηₘᵢₙ, is adjusted.

13: The method according to claim 11, wherein in the event of a deviation of the cell voltage U_{Z,N} of a battery cell (3, 4, 5, 6, 7), for which η_{N}>ηₘᵢₙ previously applied, from the end-of-charge voltage U_{L,N} by more than a specified limit value, the energy or power E_{taken,N} taken from this battery cell (3, 4, 5, 6, 7) for the adjustment of the efficiency is reduced to E_{taken,N′}, such that in future ΔU_{N}=0 applies for the voltage difference ΔU_{N}=U_{L,N}−U_{Z,N}.

14: The method according to claim 13, wherein in the case of a battery cell (3, 4, 5, 6, 7), for which η_{N}>ηₘᵢₙ previously applied and for which it is found that the voltage difference is ΔU_{N}=U_{L,N}−U_{Z,N}>0 despite a reduction to E_{taken,N′}=0, this battery cell (3, 4, 5, 6, 7) is henceforth defined as the battery cell with the lowest efficiency η_{min′}, and wherein the efficiencies of all other battery cells (3, 4, 5, 6, 7) are adjusted to this new lowest efficiency η_{min′}.

15: The method according to claim 1, wherein the charging current or the discharging current is stepped at least once while the cell block (2) is being charged or discharged, wherein a resulting step change in the cell voltage is recorded as a voltage response for all battery cells (3, 4, 5, 6, 7) and compared with one another for the battery cells (3, 4, 5, 6, 7), and wherein the energy or the power E_{taken,N}, that is taken from a battery cell (3, 4, 5, 6, 7) or multiple battery cells (3, 4, 5, 6, 7) for the adjustment of its efficiency to the efficiency ηₘᵢₙ, is adjusted if, for at least one battery cell (3, 4, 5, 6, 7), the step change in the cell voltage deviates quantitatively from the changes in the cell voltages of the other battery cells (3, 4, 5, 6, 7) by more than a specified limit value.

16: The method according to claim 15, wherein in the event of a deviation of the step change in the cell voltage of the battery cell (3, 4, 5, 6, 7) with the lowest efficiency η_{N}=ηₘᵢₙ from the changes in the cell voltages of the other battery cells by more than a specified limit value, the energy or the power E_{taken,N}, that is taken from all other battery cells (3, 4, 5, 6, 7) for the adjustment of its efficiency to the efficiency ηₘᵢₙ, is adjusted.

17: The method according to claim 15, wherein in the event of a deviation of the step change in the cell voltage of a battery cell (3, 4, 5, 6, 7), for which η_{N}>ηₘᵢₙ previously applied, from the step change of the other battery cells (3, 4, 5, 6, 7) by more than a specified limit value, the energy or the power E_{taken,N}, that is taken from this battery cell (3, 4, 5, 6, 7) for the adjustment of its efficiency, is reduced to E_{taken,N′} such that in the event of a step change in the charging or discharging current in the future the step change in the cell voltage of this battery cell (3, 4, 5, 6, 7) essentially corresponds to the step changes in the cell voltages of the other battery cells (3, 4, 5, 6, 7).

18: The method according to claim 17, wherein in the case of a battery cell for which η_{N}>ηₘᵢₙ previously applied and for which it is found that the step change in the cell voltage of this battery cell (3, 4, 5, 6, 7) as a response to a step change in the charging current or discharging current is greater than the step changes in the cell voltages of the other battery cells (3, 4, 5, 6, 7) by more than a specified limit value despite a reduction to E_{taken,N′}=0, this battery cell (3, 4, 5, 6, 7) is henceforth defined as the battery cell with the lowest efficiency η_{min′}, and wherein the efficiencies of all other battery cells (3, 4, 5, 6, 7) are adjusted to this new lowest efficiency η_{min′}.

19: The method according to claim 1, wherein the efficiency is adjusted using switchable resistors R_{N}, whereby each battery cell is equipped with a switchable resistor.

20: The method according to claim 19, wherein the resistor R_{N} (8, 9, 10, 11, 12) of the battery cells (3, 4, 5, 6, 7) is set such that for each combination of battery cell (3, 4, 5, 6, 7) and associated switchable resistor (8, 9, 10, 11, 12) the efficiency is η_{N′} =ηₘᵢₙ.

21: The method according to claim 19, wherein the switchable resistors (8, 9, 10, 11, 12) are only connected in parallel over a period of time of the charging process or discharging process of the battery cells (3, 4, 5, 6, 7).

22: The method according to claim 21, wherein the duration of the period of time for each battery cell. (3, 4, 5, 6, 7) is set such that for each combination of battery cell (3, 4, 5, 6, 7) and associated switchable resistor (8, 9, 10, 11, 12) the efficiency is η_{N′}=ηₘᵢₙ.

23: The method according to claim 1, wherein the efficiency is adjusted using DC-DC converters, wherein each battery cell (3, 4, 5, 6, 7) is equipped with one DC-DC converter and the DC-DC converter is set such that for each combination of battery cell (3, 4, 5, 6, 7) and DC-DC converter the efficiency is η_{N′}=ηₘᵢₙ.
